(19) United States
(12) Patent Application Publication
(10) Pub. No.: US 2024/0337857 A1
(43) Pub. Date: Oct. 10, 2024

(54) LENS MODULE AND PHOTOGRAPHY DEVICE

(71) Applicant: GUANGZHOU LUXVISIONS INNOVATION TECHNOLOGY LIMITED, Guangzhou (CN)

(72) Inventor: Cheng-Te Tseng, Guangzhou (CN)

(73) Assignee: GUANGZHOU LUXVISIONS INNOVATION TECHNOLOGY LIMITED, Guangzhou (CN)

(21) Appl. No.: 18/400,263

(22) Filed: Dec. 29, 2023

(30) Foreign Application Priority Data
Apr. 6, 2023 (CN) 202320750322.2

(51) Int. Cl. G02B 27/64

(52) U.S. Cl. CPC G02B 27/646

(57) ABSTRACT

A lens module and a photography device are provided. The lens module includes a focusing module, a deflection base, and a soft plate. The deflection base is provided with a through slot. The focusing module is disposed in the through slot and is connected to an inner wall of the through slot, and the deflection base is configured to drive the focusing module to deflect. The soft plate includes a movable portion and a fixed portion. An end of the movable portion is provided with a folding portion, the folding portion is connected to a side wall at an end of the focusing module, and the folding portion is folded toward a lower end surface of the focusing module, to enable the movable portion to extend along the lower end surface of the focusing module toward the fixed portion and to be connected to the fixed portion.

### CROSS-REFERENCE TO RELATED APPLICATION

This non-provisional application claims priority under 35 U.S.C. § 119(a) to Patent Application No. 202320750322.2 filed in China on Apr. 6, 2023, the entire contents of which are hereby incorporated by reference.

### BACKGROUND

### Technical Field

The present invention relates to the field of photographing technologies, and in particular, to a lens module and a photography device.

### Related Art

An optical image stabilization system usually includes a gyroscope that can sense a shake of hands. The gyroscope measures an angle of a tilt of a camera caused by the shake of hands. The system then pre-measures, according to the angle, an image offset caused by the tilt, and then the system controls a lens to translate relative to an image sensor to generate an image offset with the same magnitude but in opposite directions. In this way, the image offset caused by the shake of hands is canceled out, to ensure that the camera can still keep imaging stable in a hand shaking environment.

A soft plate is usually disposed in the optical image stabilization system. One end of the soft plate is movable, and the other end is fixed. To keep the fixed end from affecting or hindering the movement of the movable end when a deflection module moves, the soft plate usually needs to be made with a large length, to enable the movable end to obtain a sufficient movement space. As a result, the soft plate occupies a large horizontal space, which greatly reduces the flexibility of designing an internal structure of the lens.

### SUMMARY

The present invention intends to at least resolve one of the technical problems in the prior art. For this, the present invention provides a lens module and a photography device that can greatly save space.

According to a first aspect of the present invention, a lens module is provided, and includes a focusing module, a deflection base, and a soft plate. The deflection base is provided with a through slot. The focusing module is disposed in the through slot and is connected to an inner wall of the through slot, and the deflection base is configured to drive the focusing module to deflect. The soft plate includes a movable portion and a fixed portion. An end of the movable portion is provided with a folding portion, the folding portion is connected to a side wall at an end of the focusing module, and the folding portion is folded toward a lower end surface of the focusing module, to enable the movable portion to extend along the lower end surface of the focusing module toward the fixed portion and to be connected to the fixed portion.

The lens module according to the embodiments of the present invention has at least the following beneficial effects.

In the embodiments of the present invention, the end of the movable portion is provided with the folding portion connected to the focusing module. The folding portion enables the movable portion to be folded toward the lower end surface of the focusing module. The folded movable portion can extend toward the fixed portion along the lower end surface of the focusing module, that is, the movable portion is folded below the focusing module, to make full use of the space in a height direction, reduce space occupied by the soft plate in a horizontal direction, reduce restrictions on the arrangement of an internal structure of the lens module, and improve the assembly flexibility of the lens module, thereby improving the universality of the lens module.

According to some embodiments of the present invention, the lens module includes a first connecting plate, a bottom end of the first connecting plate is connected to the movable portion, a top end is provided with a second bent portion that is bent downward to form a second connecting plate, and an end of the second connecting plate away from the second bent portion extends in a direction away from a side wall of the deflection base and is connected to the fixed portion.

According to some embodiments of the present invention, an edge of the deflection base is provided with a convex connecting portion, and the connecting portion is connected to the first connecting plate.

According to some embodiments of the present invention, a bottom end of the deflection base is provided with an avoidance portion that allows the movable portion to pass through, and the movable portion passes through the deflection base along the avoidance portion to be connected to the first connecting plate.

According to some embodiments of the present invention, the first connecting plate is bonded to the side wall of the deflection base.

According to some embodiments of the present invention, the movable portion is provided with a circumventing portion that is disposed in a curved manner, the circumventing portion is disposed between the first connecting plate and the folding portion, and the circumventing portion is configured to provide cushioning after the deflection base drives the focusing module to deflect.

According to some embodiments of the present invention, the circumventing portion includes a first circumventing member and a second circumventing member that are disposed symmetrically, and the first circumventing member and the second circumventing member are arc-shaped.

According to some embodiments of the present invention, the deflection base includes a deflection block and a housing, the deflection block is connected to the focusing module, the housing is provided with a limiting cavity, the deflection block is disposed in the limiting cavity, the lens module includes a driver, and the driver is configured to drive the deflection block to deflect in the limiting cavity around a horizontal direction.

According to some embodiments of the present invention, an inner wall of the deflection block is provided with a plurality of clamping grooves, a side wall of the focusing module is provided with bosses matching the clamping grooves, and the bosses are clamped in the clamping grooves.

According to a second aspect of the present invention, a photography device is provided, and includes the lens module disclosed in the first aspect of the present invention.

Additional aspects and advantages of the present invention are partially provided in the following description, and partially become apparent in the following description or understood through the practice of the present invention.

### BRIEF DESCRIPTION OF THE DRAWINGS

The present invention is further described below with reference to the accompanying drawings and embodiments.

FIG. 1 is a schematic diagram of an embodiment of a lens module according to the present invention;

FIG. 2 is an exploded view of an embodiment of a lens module according to the present invention;

FIG. 3 is a top view of an embodiment of a lens module according to the present invention;

FIG. 4 is a front view of an embodiment of a lens module according to the present invention;

FIG. 5 is a schematic diagram of a housing in an embodiment of a lens module according to the present invention;

FIG. 6 is an enlarged view at A in FIG. 2;

FIG. 7 is an enlarged view at B in FIG. 2; and

FIG. 8 is a schematic diagram of a soft plate in an embodiment of a lens module according to the present invention.

### DETAILED DESCRIPTION

Embodiments of the present invention are described in detail below, and examples of the embodiments are shown in accompanying drawings, where the same or similar elements or the elements having same or similar functions are denoted by the same or similar reference numerals throughout the description. The following embodiments described with reference to the accompanying drawings are exemplary, and are only intended to describe the present invention and cannot be construed as a limitation to the present invention.

In the description of the present invention, it should be understood that orientation or position relationships indicated by “up”, “down”, “inside”, and “outside” are based on orientation or position relationships shown in the accompanying drawings, and are used only for ease and brevity of illustration and description, rather than indicating or implying that the mentioned apparatus or components need to have a particular orientation or need to be constructed and operated in a particular orientation. Therefore, such terms should not be construed as limiting of the present invention.

In the description of the present invention, “first” and “second” are used merely for the purpose of distinguishing the technical features, and shall not be construed as indicating or implying relative importance or implying a quantity of the indicated technical features or implying a sequential relationship of the indicated technical features.

In the description of the present invention, unless otherwise expressly limited, the terms “disposed”, “mounted”, “connected”, and the like shall be broadly construed, and the technicians in the technical field belonging to the present invention may reasonably determine the specific meanings of the terms in the present invention in conjunction with the specific content of the technical solution.

Optical image stabilization (OIS) refers to optical components such as lenses are disposed in a camera or another similar imaging instrument to avoid or reduce shaking of the instrument in a process of capturing an optical signal, thereby improving imaging quality. A lens with an optical image stabilization usually means that the lens has an optical image stabilization system, including a gyroscope that can sense a shake of hands. The gyroscope measures an angle of a tilt of a camera caused by the shake of hands. The system then pre-measures, according to the angle, an image offset caused by the tilt, and then the system controls a lens to translate relative to an image sensor to generate an image offset with the same magnitude but in opposite directions. In this way, the image offset caused by the shake of hands is canceled out, to ensure that the camera can still keep imaging stable in a hand shaking environment. However, in an existing optical image stabilization system, to keep the fixed end in the soft plate from affecting or the hindering movement of the movable end when a deflection module moves, the soft plate usually needs to be made with a large length, to enable the movable end to obtain a sufficient movement space. As a result, the soft plate occupies a large horizontal space, which greatly reduces the flexibility of designing an internal structure of the lens.

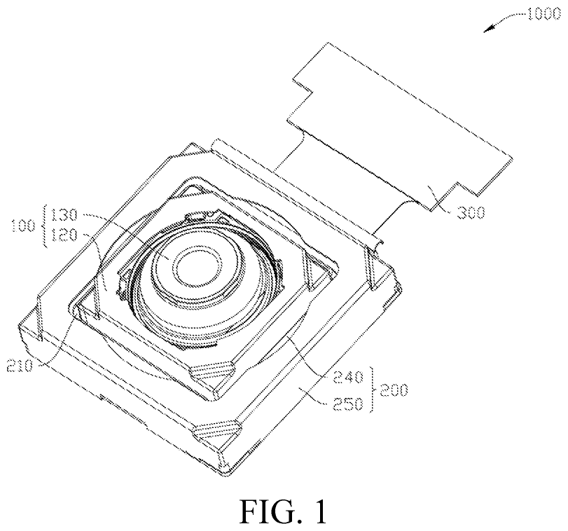

For this, some embodiments of the present invention provide a lens module 1000. For details, refer to FIG. 1 to FIG. 7 of the accompanying drawings of the specification.

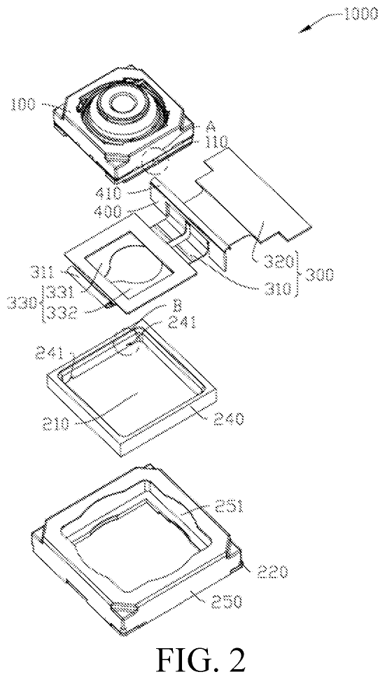

Referring to FIG. 1, in the embodiments of the present invention, the lens module 1000 includes a focusing module 100, a deflection base 200, and a soft plate 300. The deflection base 200 is provided with a through slot 210. The focusing module 100 is disposed in the through slot 210 and is connected to an inner wall of the through slot 210, and the deflection base 200 is configured to drive the focusing module 100 to deflect. Referring to FIG. 2, the soft plate 300 includes a movable portion 310 and a fixed portion 320. An end of the movable portion 310 is provided with a folding portion 311, the folding portion 311 is connected to a side wall at an end of the focusing module 100, and the folding portion 311 is folded toward a lower end surface of the focusing module 100, to enable the movable portion 310 to extend along the lower end surface of the focusing module 100 toward the fixed portion 320 and to be connected to the fixed portion 320.

Referring to FIG. 1, in the embodiments of the present invention, the focusing module 100 may include a housing 120 and a lens 130. The lens 130 may be configured to focus and acquire an image. The housing 120 can protect the lens 130 from collisions. The through slot 210 with a shape and a size matching those of the housing 120 may be disposed in the middle of the deflection base 200. The focusing module 100 may be fixedly connected to the inner wall of the through slot 210. The deflection base 200 may measure an angle of a tilt of a camera caused by the shake of hands of a user, then pre-measure, according to the angle, an image offset caused by the tilt, and then drive the focusing module 100 to move or rotate to generate an image offset with the same magnitude but in opposite directions. In this way, the image offset caused by the shake of hands of the user is canceled out, to ensure that the camera can still keep imaging stable in a hand shaking environment.

Referring to FIG. 2, in the embodiments of the present invention, a position of the fixed portion 320 of the soft plate 300 is fixed. To provide the focusing module 100 with a movement range and at the same time define the movement range of the focusing module 100, the movable portion 310 needs to be connected to the focusing module 100. When the deflection base 200 drives the focusing module 100 to deflect, the movable portion 310 can move along, and at the same time a pulling force of the movable portion 310 on the focusing module 100 can limit an offset of the focusing module 100 to keep the same from offsetting excessively. In this embodiment, an end of the movable portion 310 away from the fixed portion 320 may be connected to the side wall of the focusing module 100, and the folding portion 311 may be disposed at the end, to enable the movable portion 310 to be folded toward the lower end surface of the focusing module 100. The movable portion 310 folded below the focusing module 100 may extend along the lower end surface of the focusing module 100 toward the fixed portion 320 and may be connected to the fixed portion 320.

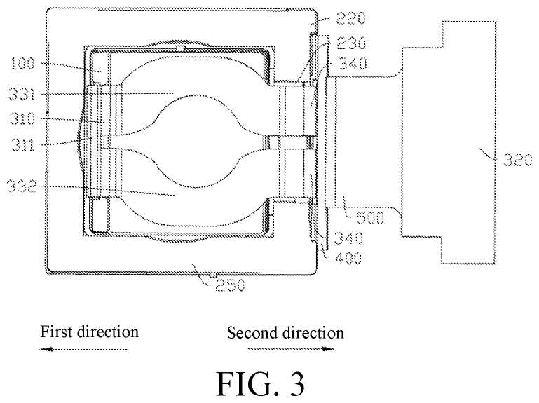

It can be understood that, referring to FIG. 3, the arrangement of the folding portion 311 may enable the movable portion 310 that should originally extend in a first direction to change to another direction through folding, so that the movable portion 310 can extend in a second direction, that is, extend along the lower end surface of the focusing module 100, to make the movable portion 310 and the focusing module 100 overlap in a height direction, thereby making full use of space in the height direction, and reducing space occupied in a horizontal direction.

In the embodiments of the present invention, the end of the movable portion 310 is provided with the folding portion 311 connected to the focusing module 100. The folding portion 311 enables the movable portion 310 to be folded toward the lower end surface of the focusing module 100. The folded movable portion 310 can extend toward the fixed portion 320 along the lower end surface of the focusing module 100, that is, the movable portion 310 is folded below the focusing module 100, to make full use of space in a height direction, reduce space occupied by the soft plate 300 in a horizontal direction, reduce restrictions on the arrangement of an internal structure of the lens module 1000, and improve the assembly flexibility of the lens module 1000, thereby improving the universality of the lens module 1000.

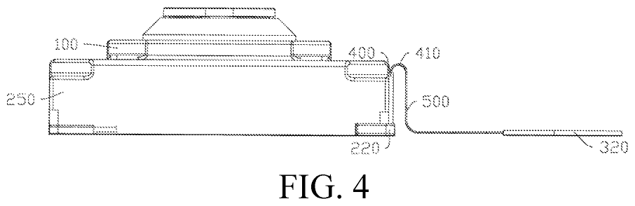

Referring to FIG. 2 and FIG. 4, in the embodiments of the present invention, the lens module 1000 includes a first connecting plate 400, a bottom end of the first connecting plate 400 is connected to the movable portion 310, a top end is provided with a second bent portion 410 that is bent downward to form a second connecting plate 500, and an end of the second connecting plate 500 away from the second bent portion 410 extends in a direction away from a side wall of the deflection base 200 and is connected to the fixed portion 320.

Referring to FIG. 2, in the embodiments of the present invention, the first connecting plate 400 may be disposed at an end of the movable portion 310 away from the folding portion 311, the first connecting plate 400 may be a plate member extending upward along a side wall of the deflection base 200, and the movable portion 310 may be connected to the lower end surface of the first connecting plate. Specifically, a first bent portion 340 that is bent upward may be disposed on the movable portion 310 to make the movable portion 310 change into extending upward, to be connected to the lower end surface of the first connecting plate 400. In this embodiment, a first reinforcing member may be bonded to the first bent portion 340, so that the strength and accuracy of the first bent portion 340 are enhanced, and at the same time the soft plate 300 can be kept from bouncing back. For example, the first reinforcing member may be a polyimide resin sheet, a metal sheet, a plastic sheet, or the like. This is not limited to this embodiment.

The U-shaped second bent portion 410 may be disposed on an upper end surface of the first connecting plate 400. That is, the second bent portion 410 is bent downward and extends downward to form the second connecting plate 500, and the end of the second connecting plate 500 away from the second bent portion 410 extends in the direction away from the deflection base 200 and is connected to the fixed portion 320.

Referring to FIG. 2, in the embodiments of the present invention, the movable portion 310 may be connected to the lower end surface of the first connecting plate 400 to change to another extension direction, so that the movable portion 310 extending the second direction is changed into extending upward along the side wall of the deflection base 200, and through the arrangement of the second bent portion 410 and the second connecting plate 500, a connection to the fixed portion 320 is implemented, to make use of the space in the height direction, further reduce the space occupied by the soft plate 300 in the horizontal direction, reduce restrictions on the arrangement of the internal structure of the lens module 1000, and improve the assembly flexibility of the lens module 1000, thereby improving the universality of the lens module 1000.

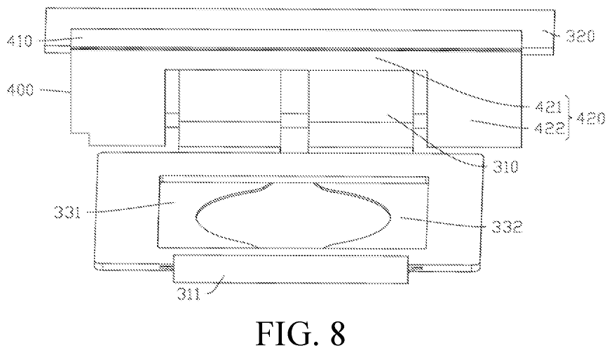

In the embodiments of the present invention, the first connecting plate 400 may have a shape that is concave in the middle and convex at two ends. Specifically, referring to FIG. 8, a second reinforcing member 420 may be disposed on the first connecting plate 400. To match the shape of the first connecting plate 400, the second reinforcing member 420 may include a concave portion 421 and two convex portions 422. The two convex portions 422 are respectively disposed at two ends of the concave portion 421. For example, the second reinforcing member 420 may be a metal sheet, a plastic sheet, or made of another hard material. This is not limited to this embodiment. For example, a thickness of the concave portion 421 may be 0.2 mm, a thickness of the two convex portions 422 may be 0.4 mm, and a spacing between the concave portion 421 and the movable portion 310 may be 0.2 mm.

Referring to FIG. 2, in the embodiments of the present invention, an edge of the deflection base 200 is provided with a convex connecting portion 220, and the connecting portion 220 is connected to the first connecting plate 400.

Referring to FIG. 3 and FIG. 4, in the embodiments of the present invention, the connecting portion 220 may be disposed at a corner of the side wall of the deflection base 200 toward the first connecting plate 400, and the connecting portion 220 and the first connecting plate 400 may be hinged, or may be bonded, or may use another connection manner, which may be selected by a person skilled in the art according to an actual case. This is not limited to this embodiment.

Referring to FIG. 3, in the embodiments of the present invention, a bottom end of the deflection base 200 is provided with an avoidance portion 230 that allows the movable portion 310 to pass through, and the movable portion 310 passes through the deflection base 200 along the avoidance portion 230 to be connected to the first connecting plate 400.

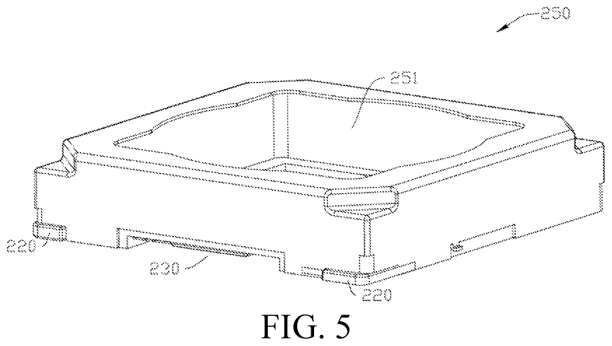

Referring to FIG. 5, in the embodiments of the present invention, the side wall of the end of the deflection base 200 toward the first connecting plate 400 may be provided with the avoidance portion 230, and the avoidance portion 230 may be a notch with a shape and a size matching those of the movable portion 310, or may be a through hole with a shape and a size matching those of the movable portion 310. This is not limited to this embodiment. The movable portion 310 may pass out from the avoidance portion 230 to be connected to the first connecting plate 400. In addition, when the deflection base 200 drives the focusing module 100 to offset, the focusing module 100 pulls the movable portion 310, and the movable portion 310 can move along the avoidance portion 230, that is, the avoidance portion 230 can further restrict that movement of the movable portion 310.

In the embodiments of the present invention, the first connecting plate 400 is bonded to the side wall of the deflection base 200.

It may be understood that when the deflection base 200 drives the focusing module 100 to offset, the focusing module 100 pulls the movable portion 310, and the movable portion 310 can move along the avoidance portion 230. However, the fixed portion 320 needs to be fixed. To prevent the movable portion 310 from pulling the fixed portion 320, in the embodiments of the present invention, the first connecting plate 400 may be bonded to the side wall of the deflection base 200 toward the first connecting plate 400, thereby preventing the movable portion 310 from pulling the fixed portion 320, and improving the structural stability of the soft plate 300.

Referring to FIG. 2 and FIG. 3, in the embodiments of the present invention, the movable portion 310 is provided with a circumventing portion 330 that is disposed in a curved manner, the circumventing portion 330 is disposed between the first connecting plate 400 and the folding portion 311, and the circumventing portion 330 is configured to provide cushioning after the deflection base 200 drives the focusing module 100 to deflect.

It needs to be noted that, because the focusing module 100 has a bouncing force after being offset, the bouncing force leads to poor shaking compensation and correction of the lens module 1000. Based on this, referring to FIG. 2 and FIG. 3, in the embodiments of the present invention, a circumventing architecture, that is, the circumventing portion 330 may be disposed between the first connecting plate 400 and the folding portion 311. The arrangement of the circumventing portion 330 can increase a length of the movable portion 310, to further reduce the bouncing force of the focusing module 100 after being offset.

Referring to FIG. 3, in the embodiments of the present invention, the circumventing portion 330 includes a first circumventing member 331 and a second circumventing member 332 that are disposed symmetrically, and the first circumventing member 331 and the second circumventing member 332 are arc-shaped.

Referring to FIG. 3, in the embodiments of the present invention, the first circumventing member 331 and the second circumventing member 332 are spaced apart and do not interfere with each other. The first circumventing member 331 and the second circumventing member 332 that are disposed to be arc-shaped can increase the length of the movable portion 310, to further reduce the bouncing force of the focusing module 100 after being offset. In addition, each of the first circumventing member 331 and the second circumventing member 332 may have a Z shape or an S shape. This is not limited to this embodiment.

Referring to FIG. 2, in the embodiments of the present invention, the deflection base 200 includes a deflection block 240 and a housing 250, the deflection block 240 is connected to the focusing module 100, the housing 250 is provided with a limiting cavity 251, the deflection block 240 is disposed in the limiting cavity 251, the lens module 1000 includes a driver, and the driver is configured to drive the deflection block 240 to deflect in the limiting cavity 251 around a horizontal direction.

Referring to FIG. 2, in the embodiments of the present invention, the housing 250 may be sleeved over an outer circumferential wall of the deflection block 240, to make the deflection block 240 located in the limiting cavity 251, and the deflection block 240 may be connected to the focusing module 100. The driver may drive the deflection block 240 to deflect in the limiting cavity 251 around the horizontal direction, to drive the focusing module 100 to deflect. The limiting cavity 251 can define the deflection block 240, thereby improving the stability of deflection.

Referring to FIG. 2, in the embodiments of the present invention, an inner wall of the deflection block 240 is provided with a plurality of clamping grooves 241, a side wall of the focusing module 100 is provided with bosses 110 matching the clamping grooves 241, and the bosses 110 are clamped in the clamping grooves 241.

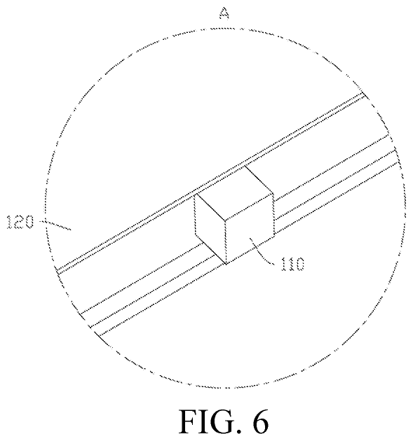

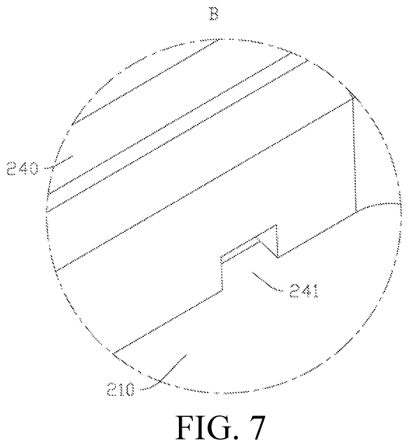

Referring to FIG. 6, in the embodiments of the present invention, the plurality of bosses 110 extending toward the deflection block 240 are spaced apart on an outer circumferential wall of the focusing module 100, and correspondingly, referring to FIG. 7, the inner wall of the deflection block 240 is provided with the clamping grooves 241 corresponding to the plurality of bosses 110. The deflection block 240 and the focusing module 100 may be clamped by the bosses 110 and the clamping grooves 241, to implement fastening between the two, thereby improving the relative stability of the deflection block and the focusing module 100.

An embodiment of the present invention further provides a photography device, including the lens module 1000 in the foregoing embodiments.

For example, the lens module 1000 may be used in various mobile terminals having a photographing function, which may be a camera, or may be a mobile phone, or may be another photography device. This is not limited to this embodiment.

The embodiments of the present invention are described above in detail with reference to the accompanying drawings. Finally, it should be noted that the foregoing embodiments are merely used for describing the technical solutions of the present invention, but are not intended to limit the present invention. Although the present invention is described in detail with reference to the foregoing embodiments, it should be appreciated by a person skilled in the art that, modifications may still be made to the technical solutions recorded in the foregoing embodiments, or equivalent replacements may be made to the part of all of the technical features; and these modifications or replacements will not cause the essence of corresponding technical solutions to depart from the scope of the technical solutions in the embodiments of the present invention.

What is claimed is:

1. A lens module, comprising:
a focusing module;
a deflection base, provided with a through slot, wherein the focusing module is disposed in the through slot and is connected to an inner wall of the through slot, and the deflection base is configured to drive the focusing module to deflect; and
a soft plate, comprising a movable portion and a fixed portion, wherein an end of the movable portion is provided with a folding portion, the folding portion is connected to a side wall at an end of the focusing module, and the folding portion is folded toward a lower end surface of the focusing module, to enable the movable portion to extend along the lower end surface of the focusing module toward the fixed portion and to be connected to the fixed portion.

2. The lens module according to claim 1, wherein the lens module comprises a first connecting plate, a bottom end of the first connecting plate is connected to the movable portion, a top end is provided with a second bent portion that is bent downward to form a second connecting plate, and an end of the second connecting plate away from the second bent portion extends in a direction away from a side wall of the deflection base and is connected to the fixed portion.

3. The lens module according to claim 2, wherein an edge of the deflection base is provided with a convex connecting portion, and the connecting portion is connected to the first connecting plate.

4. The lens module according to claim 2, wherein a bottom end of the deflection base is provided with an avoidance portion that allows the movable portion to pass through, and the movable portion passes through the deflection base along the avoidance portion to be connected to the first connecting plate.

5. The lens module according to claim 2, wherein the first connecting plate is bonded to the side wall of the deflection base.

6. The lens module according to claim 2, wherein the movable portion is provided with a circumventing portion that is disposed in a curved manner, the circumventing portion is disposed between the first connecting plate and the folding portion, and the circumventing portion is configured to provide cushioning after the deflection base drives the focusing module to deflect.

7. The lens module according to claim 6, wherein the circumventing portion comprises a first circumventing member and a second circumventing member that are disposed symmetrically, and the first circumventing member and the second circumventing member are arc-shaped.

8. The lens module according to claim 1, wherein the deflection base comprises a deflection block and a housing, the deflection block is connected to the focusing module, the housing is provided with a limiting cavity, the deflection block is disposed in the limiting cavity, the lens module comprises a driver, and the driver is configured to drive the deflection block to deflect in the limiting cavity around a horizontal direction.

9. The lens module according to claim 8, wherein an inner wall of the deflection block is provided with a plurality of clamping grooves, a side wall of the focusing module is provided with bosses matching the clamping grooves, and the bosses are clamped in the clamping grooves.

10. A photography device, comprising the lens module according to claim 1.

11. A photography device, comprising the lens module according to claim 2.

12. A photography device, comprising the lens module according to claim 3.

13. A photography device, comprising the lens module according to claim 4.

14. A photography device, comprising the lens module according to claim 5.

15. A photography device, comprising the lens module according to claim 6.

16. A photography device, comprising the lens module according to claim 7.

17. A photography device, comprising the lens module according to claim 8.

18. A photography device, comprising the lens module according to claim 9.
